(19) United States
(12) Patent Application Publication
(10) Pub. No.: US 2007/0260509 A1
(43) Pub. Date: Nov. 8, 2007

(54) System and method for express redemption of accrued rewards

(75) Inventors: Mary C. Hines, New York, NY (US); David Kroner, Woodcliff, NJ (US)

Correspondence Address: FITZPATRICK CELLA (AMEX), 30 ROCKEFELLER PLAZA, NEW YORK, NY, 10112, US

(73) Assignee: American Express Travel Related Services Company, Inc., a New York Corporation, New York, NY (US)

(21) Appl. No.: 11/314,090

(22) Filed: Dec. 22, 2005

(51) Int. Cl. G06Q 30/00

(52) U.S. Cl. 705/14

(57) ABSTRACT

Process for implementing redemption of accrued rewards from a loyalty rewards account for a benefit that is instantaneously fulfilled. The process includes linking a financial transaction instrument to the loyalty rewards account of a customer and receiving from the customer a request to redeem rewards from the loyalty rewards account for a benefit. In addition, the process automatically authorizes use of the financial transaction instrument to fulfill the benefit requested by the customer, and recognizes, across a computer network, fulfillment of the benefit by a merchant. The loyalty rewards account is automatically updated to reflect fulfillment of the benefit obtained by the customer.

### BACKGROUND OF THE INVENTION

1. Field of the Invention

The present invention generally relates to a system, method, and computer program for express redemption of rewards earned in connection with a loyalty rewards program. More particularly, the present invention relates to a process for redeeming rewards, in which a customer can fulfill a benefit in exchange for redeemed rewards with less effort and delay than in conventional programs.

2. Related Art

Conventional loyalty rewards programs, linked to financial transaction instruments (e.g., charge cards, credit cards, debit cards and the like) and their associated transaction accounts, provide rewards for commercial transactions executed using the financial transaction instrument. An example loyalty rewards program is the MEMBERSHIP REWARDS® program provided by American Express.

Loyalty rewards programs are offered in order to encourage increased spending with the instrument and continued customer loyalty. In some cases, transactions with particular merchants who are in partnership with the card issuer may result in the customer being rewarded additional loyalty rewards (e.g., double points) in order to encourage spending with that merchant (e.g., a particular airline or rental car company). Such benefits are commonly collected in a loyalty/rewards account associated with the transaction account.

Loyalty rewards accrue as the customer uses the financial transaction instrument. (Use of the instrument is defined to include using the associated transaction account by providing a merchant with the account number of the transaction account and instrument). The accrued rewards, such as points, increase with use of the instrument and are saved until such time that the customer decides to redeem the points (or other loyalty rewards) for a benefit. For instance, the customer may choose to redeem accrued points for a flight on a particular airline, a monetary credit on a store value card, credit at a particular merchant, a particular good, or a subscription. Conventionally, each available benefit is assigned a point value which corresponds to the number of points the customer must redeem to obtain the benefit.

Conventional rewards programs have suffered from the drawback that the time between the customer's request to redeem points for a benefit and the actual fulfillment of the benefit can take weeks. In the case of a gift card for a particular merchant, the customer must wait for the institution managing the loyalty account to process the request, forward it to the merchant, and have the merchant issue the gift card, which is then sent via the mail to the customer. In the case of a stored value card issued by the institution managing the loyalty account, the card must be processed so as to reflect the monetary amount redeemed, and then sent to the customer for use. Furthermore, with each redemption, a new stored value card must be processed and mailed.

Also, when multiple benefits are requested by the customer, multiple cards would have to be issued. For instance, if the customer redeemed some points for a gift card tied to a specific merchant and other points for a stored value card from the institution managing the loyalty account, the requests would have to be processed separately and two separate cards would be sent to the user, once all of the processing is completed.

There have, however, been advances to deal with the time delay in the fulfillment of the benefits. In particular, a system has been conceived in which the customer could request a benefit online and promptly be provided with an e-certificate that could be printed out by the user. The e-certificate could then be redeemed at a merchant for the selected benefit. Again, however, there are still drawbacks in this scenario, in that, e-certificates are specific to a single benefit. Furthermore, the customer must go through the step of printing out the e-certificate properly for presentation to a merchant. In addition, the employees at the merchant must be trained to recognize and properly process the e-certificate, which could lead to delays for the customer.

Given the foregoing, what is needed is a system for improved/express redemption of accrued rewards for benefits.

### BRIEF DESCRIPTION OF THE INVENTION

The present invention meets the above-identified needs by providing a system, method, and computer program for express redemption of accrued rewards. More particularly, the present invention is directed to a process of providing a reusable financial transaction instrument linked to a redemption account. The financial transaction instrument is automatically authorized for use in fulfilling the benefits requested by the customer in redeeming accrued rewards.

More specifically, the present invention is directed to a process of redeeming, across a computer network, accrued rewards from a loyalty transaction account of a customer participating in a loyalty rewards program and substantially immediately (and preferably instantaneously) authorizing fulfillment of the benefit of the rewards. The process includes linking a financial transaction instrument to be used by the customer to the loyalty transaction account of the customer and receiving from the customer a request to redeem rewards from the loyalty transaction account for the benefit. Furthermore, the process automatically authorizes use of the financial transaction instrument to fulfill immediately the benefit requested by the customer, at a merchant, and recognizes, across the computer network, fulfillment of the benefit by the merchant through the use of the financial transaction instrument to obtain the benefit. In addition, the process automatically updates the loyalty transaction account to reflect fulfillment of the benefit obtained by the customer.

In another embodiment, the present invention is directed to a process for redeeming, across a computer network, accrued rewards from a loyalty transaction account, in which the financial transaction instrument to be used by the customer is linked to the loyalty transaction account, directly or indirectly and substantially immediately authorizing fulfillment of the benefit of the rewards. The process includes receiving from the customer a request to redeem rewards in the loyalty transaction account for the benefit and associating a credit for the requested benefit with the financial transaction instrument linked to the loyalty transaction account. The process also involves recognizing, across the computer network, use of the financial transaction instrument at a merchant in a transaction to obtain the benefit, based on a request by the merchant for approval to process the transaction. The request by the merchant is approved based on the corresponding credit associated with the financial transaction instrument. Furthermore, the credit associated with the financial transaction instrument is updated based on the transaction in which the customer obtains the benefit.

Further features and advantages of the present invention as well as the structure and operation of various embodiments of the present invention are described in detail below with reference to the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a system diagram of an exemplary system in which the present invention, in an embodiment, would be implemented.

FIG. 2 is a flowchart illustrating a redemption process according to an embodiment of the present invention.

FIG. 3 is a flowchart illustrating a redemption process according to another embodiment of the present invention.

FIG. 4 is an example of a computer system that may be used to implement or embody the invention.

### DETAILED DESCRIPTION

I. Overview

The present invention is directed to a system, method, and computer program product for providing express redemption of rewards for benefits. The present invention is now described in more detail herein in terms of the above exemplary redemption system and method. This is for convenience only and is not intended to limit the application of the present invention. In fact, after reading the following description, it will be apparent to one skilled in the relevant art(s) how to implement the following invention in alternative embodiments.

The terms “user”, “end user”, “consumer”, “customer”, “participant”, “owner”, “requester” and/or the plural form of these terms are used interchangeably herein to refer to those persons or entities capable of accessing, using, being affected by and/or benefiting from the present invention.

A “financial instrument issuer” or “financial institution” is any entity that maintains transaction accounts for customers to conduct financial transactions using a financial transaction instrument. An example of such an entity is American Express, or any other company that provides members with transaction instruments and thereby maintains corresponding transaction accounts.

“Loyalty rewards” may be any sort of general measure that an account holder, designated assistant, or other authorized user of the account accumulates for management functions with the transaction account or purchases made from particular partners. Such rewards may appear as data, generated at the time of transaction, and may be awarded in a physical embodiment such as, for example, a printable coupon to a particular assistant or holder. These rewards may later be redeemed for any number of benefits including, but not limited to, money back on select purchases, points applied toward future discount prices, eligibility for sweepstakes, free merchandise offered by specific partners, credits at specific vendors, credit on stored value instruments, subscriptions, and other types of benefits not specifically recited herein.

Furthermore, the terms “business”, “merchant”, “vendor”, “service” and/or “representative” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an online merchant or the like.

Similarly, a “partner” is any person, entity, distributor system, software and/or hardware that is a provider, broker and/or any other entity in the distribution chain of goods or services, that has a pre-existing contractual arrangement with the financial instrument issuer to provide loyalty rewards to account holders for financial transactions with that particular partner.

A “transaction account” as used herein refers to an account associated with an open account or a closed account system (as described below). The transaction account may exist in a physical or non-physical embodiment. For example, a transaction account may be distributed in non-physical embodiments such as an account number, frequent-flyer account, loyalty rewards account, telephone calling account or the like. Furthermore, a physical embodiment of a transaction account may be distributed as a financial transaction instrument. Uses of such an instrument are defined herein to include uses of the account itself, even if the physical instrument itself is not presented. The term “traditional transaction account” is used herein to refer to a transaction account that a customer uses to make purchases for which the customer is charged (e.g., a credit card or debit card). Such a traditional transaction account can be combined with a redemption feature (for fulfillment of redeemed rewards) to form a hybrid transaction account, as will be discussed in more detail below.

A financial transaction instrument may include traditional plastic transaction cards, titanium-containing, or other metal-containing, transaction cards, clear and/or translucent transaction cards, foldable or otherwise unconventionally-sized transaction cards, radio-frequency enabled transaction cards, or other types of transaction cards, such as credit, charge, debit, pre-paid or stored-value cards, or any other like financial transaction instrument. A financial transaction instrument may also have electronic functionality provided by a network of electronic circuitry that is printed or otherwise incorporated onto or within the transaction instrument (and typically referred to as a “smart card”), or be a fob having a transponder and an RFID reader.

“Open cards” are financial transaction cards that are generally accepted at different merchants. Examples of open cards include the American Express®, Visa®, MasterCard® and Discover cards, which may be used at many different retailers and other businesses. In contrast, “closed cards” are financial transaction cards that may be restricted to use in a particular store, a particular chain of stores or a collection of affiliated stores. One example of a closed card is a pre-paid gift card that may only be purchased at, and only be accepted at, a clothing retailer, such as The Gap® store.

Stored value cards are forms of transaction instruments associated with transaction accounts, wherein the stored value cards provide cash equivalent value that may be used within an existing payment/transaction infrastructure. Stored value cards are frequently referred to as gift, pre-paid or cash cards, in that money is deposited in (or a credit is applied to) the account associated with the card before use of the card is allowed. For example, if a customer deposits ten dollars of value into the account associated with the stored value card, the card may only be used for payments up to ten dollars.

With regard to use of a transaction account, users may communicate with merchants in person (e.g., at the box office), telephonically, or electronically (e.g., from a user computer via the Internet). During the interaction, the merchant may offer goods and/or services to the user. The merchant may also offer the user the option of paying for the goods and/or services using any number of available transaction accounts. Furthermore, the transaction accounts may be used by the merchant as a form of identification of the user. The merchant may have a computing unit implemented in the form of a computer-server, although other implementations are possible.

In general, transaction accounts may be used for transactions between the user and merchant through any suitable communication device, such as, for example, a telephone network, intranet, the global, public Internet, a point of interaction device (e.g., a point of sale (POS) device, personal digital assistant (PDA), mobile telephone, kiosk, etc.), online communications, off-line communications, wireless communications, and/or the like.

An “account,” “account number” or “account code”, as used herein, may include any device, code, number, letter, symbol, digital certificate, smart chip, digital signal, analog signal, biometric or other identifier/indicia suitably configured to allow a consumer to access, interact with or communicate with a financial transaction system. The account number may optionally be located on or associated with any financial transaction instrument (e.g., rewards, charge, credit, debit, prepaid, telephone, embossed, smart, magnetic stripe, bar code, transponder or radio frequency card).

The account number may be distributed and stored in any form of plastic, electronic, magnetic, radio frequency (RF), wireless, audio and/or optical device capable of transmitting or downloading data from itself to a second device. A customer account number may be, for example, a sixteen-digit credit card number. Each credit card issuer has its own numbering system, such as the fifteen-digit numbering system used by American Express Company of New York, N.Y. Each issuer's credit card numbers comply with that company's standardized format such that an issuer using a sixteen-digit format will generally use four spaced sets of numbers in the form of:
N₁N₂N₃N₄N₅N₆N₇N₈N₉N₁₀N₁₁N₁₂N₁₃N₁₄N₁₅N₁₆

The first five to seven digits are reserved for processing purposes and identify the issuing institution, card type, etc. In this example, the last (sixteenth) digit is typically used as a sum check for the sixteen-digit number. The intermediary eight-to-ten digits are used to uniquely identify the customer, card holder or cardmember. A merchant account number may be, for example, any number or alpha-numeric characters that identifies a particular merchant for purposes of card acceptance, account reconciliation, reporting and the like.

Further, a “loyalty account” or “rewards account” can be any database or electronic entry that collects, stores and tabulates the number and type of loyalty rewards for a particular individual. This loyalty account is configured to allow a consumer to access, interact with, or communicate the information therein to a financial transaction system. A loyalty account may be maintained by either the transaction instrument issuer or, alternatively, a separate entity. A loyalty (rewards) transaction account is used herein to signify a loyalty account that the customer uses to redeem rewards for a benefit in the manner discussed throughout the application.

II. System

A. Database System

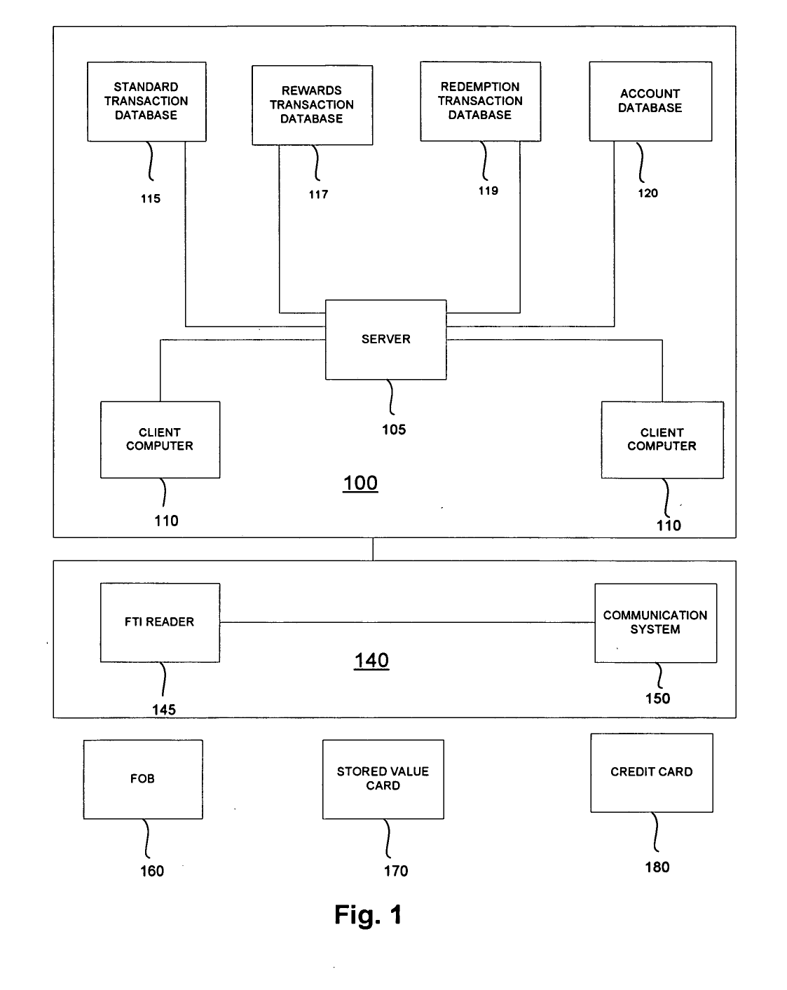

FIG. 1 is a system diagram of an exemplary embodiment of the present invention. In this embodiment, the issuer of financial transaction instruments maintains an accounts system 100, which processes and stores information relating to various accounts. Accounts system 100 may include, for example, a server 105 configured to communicate with a number of client computers 110 via a network (or a mainframe computer configured to communicate with a number of terminals).

Accounts system 100 also includes a redemption transaction database 119, standard transaction database 115, rewards transaction database 117, and an account database 120. During operation, any data regarding a particular account holder is stored in the appropriate corresponding database associated with accounts system 100, with server 105 (or other connected computer) processing the data among the several linked databases and clients. In other embodiments, the database may be contained in separate systems in communication with each other through a network or the like.

Account database 120 stores identification, personal, and contact information provided to the transaction instrument issuer by account holders. This account information may, for example, include a holder's name, residence, Social Security number, employer, contact information, and the like. In other embodiments, that information may be maintained for each transaction account and, possibly, in the transaction database holding information concerning the transaction account.

Standard transaction database 115 stores information relating to transactions conducted with a standard financial transaction instrument (standard FTI) linked to the transaction account. For example, when an account holder makes a purchase from a merchant using the linked standard FTI, data relating to the transaction is transmitted from the merchant to the issuer. Assuming the transaction is approved, the issuer pays the merchant and bills the account holder. This transaction data is managed in transaction database 115 for such purposes, among others.

Rewards transaction database 117 stores information relating to the loyalty rewards account related to the standard transaction accounts. For example, when a holder uses the standard FTI linked to a standard transaction account, loyalty rewards are accrued and information concerning the same is stored in rewards transaction database 117.

Redemption transaction database 119 stores information relating to the use of a redemption financial transaction instrument (redemption FTI) in obtaining benefits, which the customer has requested in exchange for redemption of loyalty rewards. Once the rewards are redeemed, the benefits may be obtained using the redemption FTI linked to redemption transaction database 119. Thus, redemption transaction database 119 may be linked to rewards transaction database 117, such that once rewards in the loyalty rewards account are exchanged for the right to a benefit, authorization/credit for the benefit is reflected in the redemption account. The redemption FTI is a reusable instrument for use in fulfilling/obtaining benefits selected in exchange for rewards. Because the redemption FTI is linked to a redemption transaction account, it can automatically be used for obtaining benefits authorized in such an account, as will be discussed in more detail below. The redemption FTI may be issued by the financial institution and linked to an account in any one of a number of conventional manners. In this regard, the redemption FTI may act much like a reusable stored value card, albeit with more associated functionality, in which value is added by the redemption of rewards.

Of course, the present invention is not limited to the databases mentioned above, and additional databases for storing other information may be provided as part of transaction accounts system 100. In addition, these databases may be combined as necessary, physically and/or functionally. In particular, rewards transaction database 117 and redemption transaction database 119 are described separately for ease of description, but can be combined. Specifically, while a rewards transaction account and a redemption transaction account are defined separately, the functionality of these two accounts may be combined, depending upon the issuer's preferred practice. Particularly, with respect to the claims, one account may be recited to cover the functionality of both accounts as described in the preferred examples. In addition, while external databases are shown, one of ordinary skill in the art will appreciate that any one of a number of storage systems may be used to maintain the necessary account information.

Server 105 is also in communication with a vendor system 140, which includes a communication system 150 and a financial transaction instrument (FTI) reader 145.

FTI reader 145 reads data from a financial transaction instrument such as FOB 160, stored value card 170, and credit card 180. Based on the information read by FTI reader 145, communication system 150 contacts account system 100 of the FTI issuer to request authorization for payment. Specifically, when a customer attempts to purchase merchandise using a financial transaction instrument, the merchant system 140 requests and obtains authorization from the financial institution in order to process the transaction.

As noted above, one or more client computers 110 associated with transaction accounts system 100 are capable of accessing this system to retrieve information from databases 115, 117, 119, and 120. It is to be understood that although only two client computers 110 are depicted, there may be numerous computers connected to transaction accounts server 105 via various types of network and direct connections. These client computers may include customer computers through which clients access their accounts and submit requests to redeem accrued rewards. The client computer may also include computers of the financial institution through which employees can access the accounts.

B. Redemption System

As discussed, a loyalty rewards program is associated with a rewards transaction account so as to provide the customer the ability to earn loyalty rewards based on the use of, typically, the standard FTI (including use of only the account number in initiating transactions). Specifically, when a financial transaction instrument linked to the standard transaction account is used to make purchases, the customer's loyalty rewards account is provided with rewards corresponding to the volume or type of use of that financial transaction instrument. Thus, a rewards transaction database may be used to monitor and manage the customer's loyalty rewards earned.

Typically, loyalty rewards are measured/provided in points or other increments that are earned based on values associated with frequency, volume, or types of activities connected with the associated transaction account. For instance, a customer could earn a fixed-point amount for every dollar spent using the standard FTI, although any other rules could govern the awarding of points within the scope of the invention (e.g., the number of points per dollar spent could increase with the total number of dollars spent in a specified period, up to a ceiling rate). Points accruing in a loyalty rewards account of a user could be linked to multiple transaction accounts or financial transaction instruments.

Once accrued, the points can be redeemed for specified benefits. For instance, points can be redeemed for a benefit such a plane ticket that is offered for a fixed number of points. Thus, the customer can redeem the number of points required to obtain the plane ticket.

This is, of course, one example of an implementation of a loyalty rewards program. One of ordinary skill in the relevant art will appreciate that variations of such a loyalty rewards program are possible.

The available types of benefits could include credit (e.g., monetary credit for use at any merchant accepting the financial transaction instrument of the financial institution, credit specific to a particular merchant, etc.), merchandise (e.g., specific products, typically offered by specific merchants), subscriptions (e.g., a benefit that grants the customer the right to obtain a predetermined number of items during a predetermined increment of time, for each predetermined increment over the length of a set period), etc. As will be appreciated, any one of a number of other types of benefits can be provided in association with a loyalty rewards program.

As discussed, the present invention is directed to an express system for redeeming loyalty rewards for one or more benefits, such that the customer can obtain/fulfill the benefit faster and/or more easily than in conventional loyalty rewards programs.

In this embodiment, as standard transaction database 115 is updated with transaction information related to a linked financial transaction instrument (e.g., credit card, debit card, and the like), rewards transaction database 117 is updated to reflect the loyalty rewards earned from the use of the standard transaction account. Once sufficient loyalty rewards have accrued in a customer's loyalty rewards account, the customer may redeem the rewards for a benefit.

In a preferred embodiment, a customer uses a client computer 110 to access server 105, or other system through which the customer can submit a request to redeem loyalty rewards for a benefit. Preferably, client computer 110 connects with server 105 via an Internet connection. In alternative embodiments, however, a customer may redeem loyalty rewards by contacting the financial institution over telephone lines, with an oral request. In any event, the customer submits a request to redeem accrued loyalty rewards, available in a rewards account, for a benefit available for the rewards amount being redeemed.

In the present invention, accounts system 100 automatically processes the request (whether entered into the system through client computer 110 operated by the customer, or a client computer 110 operated by an employee of the financial institution receiving the customer's request).

In a preferred embodiment, the automatic processing is achieved by linking the loyalty rewards account in rewards transaction database 117 with a redemption transaction account in redemption transaction database 119. The customer request is automatically processed such that the redemption transaction account is updated to reflect the benefit selected (in exchange for the specified value of loyalty rewards). For instance, where the request is for a credit of $50 at a specific merchant, redemption transaction database 119 is updated such that the redemption transaction account reflects the credit (or other indication of authorization for the benefit) and merchant identification. In addition, the loyalty rewards account is updated to reflect the expenditure of the rewards used to obtain the benefit. Of course, the updating of these accounts may take place in any number of ways (and with a number of possible storage management systems) to authorize, automatically, use of the redemption FTI to obtain the selected benefit.

In particular, the manner in which the benefit information is recorded in redemption transaction database 119 can be modified as needed to properly manage the system. Preferably, redemption transaction database 119 also processes requests from merchants to authorize transactions by the customer to obtain/fulfill the requested benefit, and processes and updates the redemption transaction account to reflect the fulfillment of the benefit by the customer. Thus, transactions using a redemption FTI can be routed specifically for reconciliation with that database.

In a preferred embodiment, a redemption transaction account may store information concerning multiple benefits requested by the customer simultaneously. For instance, a customer may request redemption of loyalty rewards for a first benefit (e.g., $50 for use at a specific merchant) and a second benefit (e.g., $100 credit for use at a second vendor, different from the first merchant). In such situations, redemption transaction database 119 stores and monitors information related to both benefits simultaneously, and differentiates between requests for authorization from merchants related to the different benefits. For instance, this could include recognizing a request for payment authorization by the first vendor for $40, updating the redemption transaction account to reflect $10 of remaining credit for the first vendor, while not changing the status of the $100 credit available for use at the second merchant. The differentiation may be accomplished based on the information provided by a merchant in a request for payment authorization, as will be discussed in more detail below.

The redemption transaction account may be linked to one or more financial transaction instruments. Preferably, the redemption FTI linked to the redemption transaction account is dedicated to that account, and is not directly linked to a standard transaction account of standard transaction database 15. For instance, it is preferred that a financial transaction instrument such as FOB 160 or stored value card 170 be linked to the redemption transaction account, while a credit card 180 or the like, should preferably be separately linked to the standard transaction account. In such circumstances, it is preferable that FOB 160 or stored value card 170 be dedicated for use with a redemption account, so as to serve as a redemption FTI. By having a dedicated redemption FTI, the customer and the merchant do not have to specify which account is to be used in purchasing an item. In other words, if the redemption FTI is combined with a standard FTI such that two accounts are linked to the one instrument, the customer and merchant could be forced to select between the two or more possible accounts. A dedicated FTI provides a more reliable and efficient process, further cutting down the steps necessary for the customer to obtain/fulfill the selected benefit.

In other embodiments, however, a single financial transaction instrument may be linked to both the standard transaction account and the redemption transaction account. In such a case, it is preferable that the customer, when making a purchase at a merchant, specify whether the standard transaction account is to be used for the purchase or the redemption transaction account is to be used (or possibly a combination, as will be discussed below).

With the foregoing setup, once a customer submits a request to redeem rewards for a benefit using client computer 110, or other requests submission system, the request is automatically processed (for example, by rewards transaction database 117, to update the redemption transaction account of redemption transaction database 119) so that the redemption FTI can be used to obtain the benefit(s). Thus, redemption transaction database 119 is automatically configured to recognize and authorize requests associated with the benefit requested by the client. Consequently, after submitting the requests, the customer's redemption FTI, such as stored value card 170, is automatically, and substantially immediately, available for use to obtain the benefit.

The redemption FTI can then be used at a merchant to obtain/fulfill a benefit. For instance, the mechanism for doing so may be much like a traditional transaction in which a customer uses a credit card or stored value card to purchase an item. The customer obtains the product (in this case, the requested benefit) and initiates payment for the same using the redemption FTI linked to the redemption transaction account (which has been updated with the necessary benefit information).

When the merchant is presented with stored value card 170 linked to the redemption transaction account, the merchant may use an FTI reader 145 to read data from stored value card 170. In connection with other computers or processing systems of merchant system 140, communication system 150 sends a request for payment authorization to the financial institution (issuer of the FTI). This may be accomplished over a telephone line or Internet connection that connects communication system 150 and accounts system 100 together.

The request can include data from stored value card 170 identifying account information (which identifies a redemption account of redemption transaction database 119), merchant identification information, the amount of the transaction, and any other necessary data that the financial institution would need to review and approve the request.

Account system 100 processes the requests. Specifically, server 105 queries redemption transaction database 119 to determine if the request for payment authorization corresponds to the benefit information in the redemption transaction account.

For instance, when the reward reflected in the redemption transaction database 119 is a $150 credit at a specific merchant, it is determined that the specified merchant corresponds to the merchant ID information communicated from communication system 150 and that the amount to be authorized is less than or equal to the $150 credit amount recorded in the database.

If the request for payment authorization is approved, a communication indicating the same is sent from server 105 to communication system 150 of merchant system 140. In addition, redemption transaction database 119 is updated to reflect the expenditure at the merchant (e.g., subtracting the amount expended by the customer at the merchant from the credit available in the redemption transaction account).

If server 105 determines that the credit available in the redemption transaction account does not cover the payment authorization requested by merchant system 140, the request can be denied, or the request can be approved for the amount available in the redemption transaction account. The remaining amount of the purchase price can be attended to by the customer by alternative means. In other embodiments, however, if the payment amount requested by merchant 140 is greater than the credit available in the redemption transaction account, the server 105 can be programmed to query standard transaction database 115 to determine if the customer has an associated standard transaction account available for use in purchasing the item. If such a standard transaction account is available, server 105 can use the credit available in the redemption transaction account, and apply the remaining balance to the associated standard transaction account of standard transaction database 115. In this case, the request for payment authorization can be approved, although the transaction is a split tender transaction between multiple accounts of the customer.

Where the benefit being fulfilled at the merchant site is a specific product, vendor system 140 can transmit SKU information that identifies the product that the customer is attempting to purchase using stored value card 170 or FOB 160. In this case, redemption transaction database 119 can have information concerning the SKU number in connection with the requested benefit. As will be appreciated by one of ordinary skill in the relevant art, a number of different types of data can be used to accomplish the transaction. While the communication of such data between merchant system 140 and account system 100 may require upgrades on both the financial institution's side and the merchant's side, such upgrades are within the skill of one of ordinary skill in the relevant art.

In other embodiments, the benefit may be a subscription. A subscription may be a right to obtain a predetermined number of items (e.g., one or more cups of coffee) during a predetermined increment of time (e.g., one day), for each predetermined increment over the length of a set period of time (e.g., one month). For instance, the customer may request as the benefit a subscription to obtain one cup of coffee a day from a specific merchant for a period of one month. In such a circumstance, the customer may use stored value card 170 to obtain a cup of coffee from the merchant. The request for payment authorization from merchant system 140 will cause redemption transaction database 119 to update the associated account to indicate that the customer has fulfilled the benefit for that day. Consequently, the customer will not be able to use stored value card 170 to obtain any other cup of coffee for that day. The redemption transaction database 119 updates itself the next day to reauthorize the purchase of one cup of coffee at the specified merchant so that the customer may fulfill the reward during the next increment of the subscription term.

With the foregoing system, account system 100 can recognize the selection of one or more benefits by a customer in exchange for accrued rewards in a rewards account, and update system 100 to reflect the right to obtain the selected benefit. This allows for automatic and substantial immediate authorization for the customer to use a reusable redemption FTI, or other linked financial transaction instrument to obtain/fulfill the reward, in which case account system 100 automatically updates information to reflect fulfillment of the reward.

III. Process

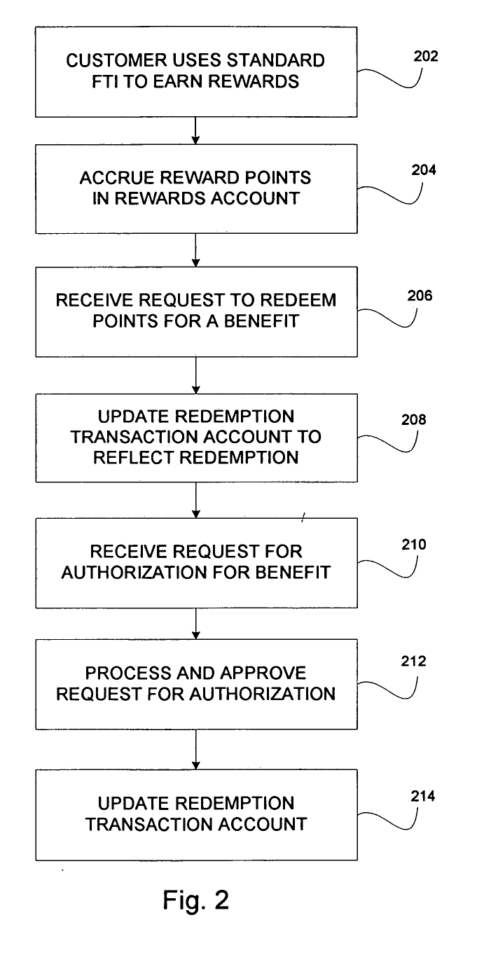

FIG. 2 is a flowchart illustrating a rewards redemption process 200, according to one embodiment of the present invention.

In step 202, the customer uses their credit card to earn loyalty rewards. In step 204, the rewards automatically accrue in a rewards account linked to the standard transaction account corresponding to the credit card. In step 206, the customer requests to redeem the accrued points for a benefit available for the rewards amount being redeemed. In this example, the benefit is a $100 credit at a specified merchant. Step 206 may involve the customer logging onto a website of the financial institution to submit electronically the request to redeem rewards. Alternatively, the request may be made by telephone or other suitable manner. Regardless of the manner in which the request is submitted, the request is ultimately provided to a computer system such that, in step 208, a redemption account is automatically updated to reflect the redemption of accrued rewards for a specified benefit. Specifically, the redemption account is updated to include information indicative of the $100 credit/value and the identity of the merchant at which the credit may be exercised. This has the effect of automatically authorizing fulfillment of the benefit at the merchant. It should be also noted that, in this particular embodiment, the rewards and redemption accounts are separate; however, in other embodiments, the accounts may be combined in one system, or partially combined (functionally and/or physically).

Once the redemption account is automatically updated with the information concerning the benefit, a redemption FTI linked to the redemption transaction account may be used to obtain the benefit from the specified merchant. Accordingly, the customer can, without waiting for a gift card or gift certificate to be mailed, take a previously issued redemption FTI and present the same at a merchant for acquisition of the benefit.

When the customer attempts to purchase the benefit, the merchant, in step 210, begins to process the transaction such that a request for payment authorization for a $50 purchase, for instance, is received by the financial institution of record for the redemption FTI. The request for payment authorization may include information concerning the account data from the redemption FTI, the amount of the purchase price, the merchant ID, SKU information, etc.

In step 212, the request for payment authorization received from the merchant is processed by the financial institution. This involves querying the redemption transaction account database to determine whether there is a credit available for the transaction information provided by the merchant. Once the financial institution determines that the credit is available for the purchase price and for the specified merchant, the request for payment authorization is approved.

The redemption transaction account is updated to reflect that $50 of the $100 credit at the specified merchant has been expended by the customer, leaving a remaining $50 credit available for future use at that specified merchant.

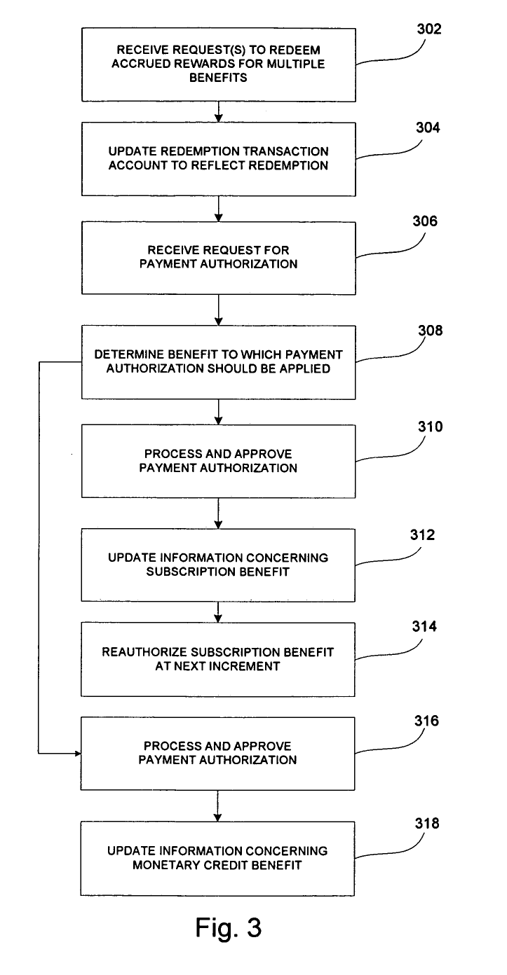

FIG. 3 is a flowchart illustrating another rewards redemption process 300, according to another embodiment of the present invention.

In step 302, the customer submits a request to redeem accrued rewards in their rewards account for two separate benefits. In this example, the two benefits are a monetary credit benefit (in this case, a $50 credit good at any merchant accepting the redemption FTI) and a subscription benefit (in this case, a cup of coffee a day for one month from a specified merchant).

In step 304, the redemption account associated with the loyalty rewards account is updated to reflect information indicative of the customer's right to obtain the two different benefits. This may include providing information regarding the monetary credit of $50 in the redemption account, and information indicating that the credit may be used at any merchant. With respect to the subscription benefit, the redemption account may be updated to include information indicative of the length of the subscription, the time increments within the subscription during which the customer has the right to obtain one cup of coffee, the merchant ID, the SKU number for the authorized coffee, etc.

In step 306, the financial institution receives a request for payment authorization from a merchant. This occurs when the customer uses the redemption FTI to purchase a product. In this case, the product being purchased is a cup of coffee. In step 308, it is determined whether the request for payment authorization corresponds to the monetary credit benefit or the subscription benefit.

If the request for payment authorization corresponds to the subscription benefit, then the process proceeds to step 310, in which the request for payment authorization is processed and authorized in a manner consistent with the operations discussed in detail above. Once authorized, the merchant completes the transaction and provides the customer with the cup of coffee.

In step 312, the redemption transaction account is updated to reflect that the cup of coffee for that day has been obtained by the customer, and consequently, the customer will not be able to use the redemption FTI to obtain another cup of coffee for that day, with respect to the subscription benefit. In step 314, the redemption transaction account is automatically reauthorized at the beginning of the next day to reflect that the customer is again entitled to receive one cup of coffee from the specified merchant. Alternatively, if a cup of coffee is not obtained on a given day, the benefit expires at the end of the day and is reauthorized in step 314 for the next day in a similar manner.

If in step 310 it is determined that the cup of coffee for that day has already been obtained by the customer, the process proceeds to step 316, in which the system attempts to authorize the purchase using another available benefit. In this regard, when more than one benefit could be used in authorizing (i.e., applies to) the transaction, the method preferably uses the most specific benefit first (e.g., a credit specific to a merchant over a credit available for any merchant; the right to a specific product at a specific merchant over a credit at that specific merchant; etc.). In this step, the request for payment authorization is approved with respect to the information concerning the $50 monetary credit benefit available at any merchant.

In step 318, the redemption transaction account is updated to subtract the price of the coffee from the $50 monetary credit.

The methods described above with respect to FIGS. 2 and 3 are only examples of embodiments of the invention. One of ordinary skill in the art will appreciate that any one of a number of other variations may be used in achieving an express rewards program in accordance with the invention.

IV. Example Implementations

The present invention may be implemented using hardware, software or a combination thereof and may be implemented in one or more computer systems or other processing systems. However, the manipulations performed by the present invention were often referred to in terms, such as adding or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices, such as server 105.

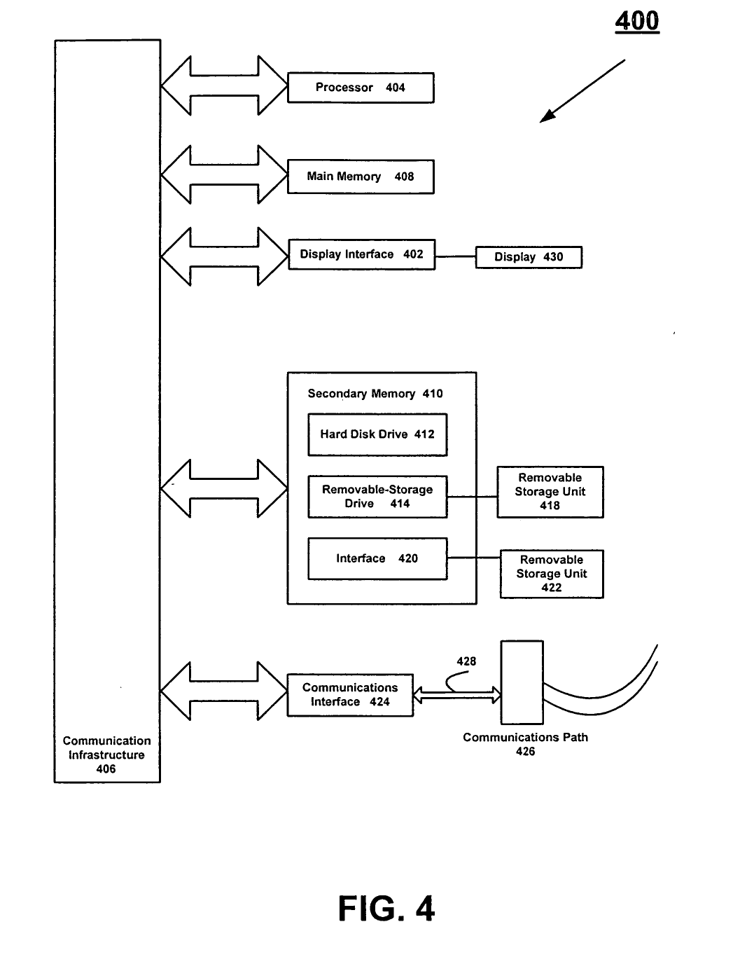

In fact, in one embodiment, the invention is directed toward one or more computer systems capable of carrying out the functionality described herein as discussed above, particularly with respect to accounts system 100. An example of a computer system 400 that may be used in accounts system 100 is shown in FIG. 4.

The computer system 400 includes one or more processors, such as processor 404. The processor 404 is connected to a communication infrastructure 406 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 400 can include a display interface 402 that forwards graphics, text, and other data from the communication infrastructure 406 (or from a frame buffer not shown) for display on the display unit 430.

Computer system 400 also includes a main memory 408, preferably random access memory (RAM), and may also include a secondary memory 410. The secondary memory 410 may include, for example, a hard disk drive 412 and/or a removable storage drive 414, representing a floppy disk drive, a magnetic tape drive, an optical disk drive, etc. The removable storage drive 414 reads from and/or writes to a removable storage unit 418 in a well known manner. Removable storage unit 418 represents a floppy disk, magnetic tape, optical disk, etc. which is read by and written to by removable storage drive 414. As will be appreciated, the removable storage unit 418 includes a computer usable storage medium having stored therein computer software and/or data.

In alternative embodiments, secondary memory 410 may include other similar devices for allowing computer programs or other instructions to be loaded into computer system 400. Such devices may include, for example, a removable storage unit 422 and an interface 420. Examples of such may include a program cartridge and cartridge interface (such as that found in video game devices), a removable memory chip (such as an erasable programmable read only memory (EPROM), or programmable read only memory (PROM)) and associated socket, and other removable storage units 422 and interfaces 420, which allow software and data to be transferred from the removable storage unit 422 to computer system 400.

Computer system 400 may also include a communications interface 424. Communications interface 424 allows software and data to be transferred between computer system 400 and external devices. Examples of communications interface 424 may include a modem, a network interface (such as an Ethernet card), a communications port, a Personal Computer Memory Card International Association (PCMCIA) slot and card, etc. Software and data transferred via communications interface 424 are in the form of signals 428 which may be electronic, electromagnetic, optical or other signals capable of being received by communications interface 424. These signals 428 are provided to communications interface 424 via a communications path (e.g., channel) 426. This channel 426 carries signals 428 and may be implemented using wire or cable, fiber optics, a telephone line, a cellular link, a radio frequency (RF) link and other communications channels.

In this document, the terms “computer program medium” and “computer usable medium” are used to generally refer to media such as removable storage drive 414, a hard disk installed in hard disk drive 412, and signals 428. These computer program products provide software to computer system 400. The invention is directed to such computer program products.

Computer programs (also referred to as computer control logic) are stored in main memory 408 and/or secondary memory 410. Computer programs may also be received via communications interface 424. Such computer programs, when executed, enable the computer system 400 to perform the features of the present invention, as discussed herein. In particular, the computer programs, when executed, enable the processor 404 to perform the features of the present invention. Accordingly, such computer programs represent controllers of the computer system 400.

In an embodiment where the invention is implemented using software, the software may be stored in a computer program product and loaded into computer system 400 using removable storage drive 414, hard drive 412 or communications interface 424. The control logic (software), when executed by the processor 404, causes the processor N04 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

### V. CONCLUSION

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures and screen shots illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the steps and processes recited in the claims need not be performed in the order presented.

What is claimed is:

1. A method of redeeming, across a computer network, accrued rewards from a loyalty transaction account for a benefit, in connection with use of a financial transaction instrument, the method comprising the steps of:
linking the financial transaction instrument to be used by a customer to the loyalty transaction account of the customer;
receiving from the customer a request to redeem rewards from the loyalty transaction account for the benefit;
automatically authorizing use of the financial transaction instrument to fulfill the benefit requested by the customer;
recognizing, across the computer network, fulfillment of the benefit by the merchant through the use of the financial transaction instrument to obtain the benefit; and
automatically updating the loyalty transaction account to reflect fulfillment of the benefit obtained by the customer.

2. The method of claim 1, wherein the financial transaction instrument is dedicated for use with only the loyalty transaction account.

3. The method according to claim 1, wherein, in said receiving step, a request to redeem rewards for a plurality of different benefits is received, and said authorization step includes automatically authorizing use of the financial transaction instrument to fulfill each of the plurality of different benefits.

4. The method according to claim 3, wherein at least two of the plurality of benefits are specific to different merchants.

5. The method according to claim 1, wherein the benefit is a subscription benefit that grants the customer a right to obtain a predetermined number of items during a predetermined increment of time, for each predetermined increment over the course of a set period of time.

6. The method according to claim 5, wherein acquisition of the predetermined number of items is restricted to the same merchant for each increment.

7. The method according to claim 1, wherein the financial transaction instrument can be reused in connection with a plurality of different requests to redeem rewards for different benefits.

8. The method according to claim 2, wherein the financial transaction instrument can be reused in connection with a plurality of different requests to redeem rewards for different benefits.

9. The method according to claim 8, wherein data concerning multiple authorizations to use the financial transaction instrument to obtain each different benefit are maintained simultaneously in connection with the loyalty transaction account.

10. A computer program product comprising a computer usable medium having control logic stored therein for causing a computer to redeem, across a computer network, accrued rewards from a loyalty transaction account for a benefit, in connection with use of a financial transaction instrument, said control logic comprising:
first computer readable program code means for causing the computer to link the financial transaction instrument to be used by a customer to the loyalty transaction account of the customer;
second computer readable program code means for causing the computer to accept from a customer a request to redeem rewards from the loyalty transaction account for the benefit;
third computer readable program code means for causing the computer to authorize automatically use of the financial transaction instrument to fulfill the benefit requested by the customer;
fourth computer readable program code means for causing the computer to recognize, across the computer network, fulfillment of the benefit by the merchant through the use of the financial transaction instrument to obtain the benefit; and
fifth computer readable program code means for causing the computer to update automatically the loyalty transaction account to reflect fulfillment of the benefit obtained by the customer.

11. The computer program product of claim 10, wherein the financial transaction instrument is dedicated for use with only the loyalty transaction account.

12. The computer program product of claim 10, wherein said second computer readable program code means causes the computer to accept a request to redeem rewards for a plurality of different benefits, and said third computer readable program code causes the computer to authorize use of the financial transaction instrument to fulfill each of the plurality of different benefits.

13. The computer program product of claim 12, wherein said second computer readable program code means causes the computer to recognize at least two of the plurality of benefits as being specific to different merchants.

14. The computer program product of claim 10, wherein said second computer readable program code means causes the computer to recognize a subscription benefit that grants the customer a right to obtain a predetermined number of items during a predetermined increment of time, for each predetermined increment over the course of a set period of time.

15. The computer program product of claim 14, wherein said third computer readable program code means causes the computer to restrict acquisition of the predetermined number of items to the same merchant for each increment.

16. The computer program product of claim 10, wherein the financial transaction instrument can be reused in connection with a plurality of different requests to redeem rewards for different benefits.

17. The computer program product of claim 11, wherein the financial transaction instrument can be reused in connection with a plurality of different requests to redeem rewards for different benefits.

18. The computer program product of claim 17, wherein said third computer readable program code means causes the computer to maintain data concerning multiple authorizations to use the financial transaction instrument to obtain each different benefit simultaneously in connection with the loyalty transaction account.

19. A method of redeeming, across a computer network, accrued rewards from a loyalty transaction account for a benefit, in connection with use of a financial transaction instrument by the customer, the method comprising the steps of:
linking the financial transaction instrument to be used by the customer to the loyalty transaction account;
receiving from the customer a request to redeem rewards in the loyalty transaction account for the benefit;
automatically associating a credit for the requested benefit with the financial transaction instrument linked to the loyalty transaction account;
recognizing, across the computer network, use of the financial transaction instrument at a merchant in a transaction to obtain the benefit, based on a request by the merchant for approval to process the transaction;
approving the request by the merchant to process the transaction for the benefit based on the credit associated with the financial transaction instrument; and
updating the credit associated with the financial transaction instrument based on the transaction in which the customer obtains the benefit.

20. The method of claim 19, wherein the financial transaction instrument is dedicated for use with only the loyalty transaction account.

21. The method according to claim 20, wherein the financial transaction instrument can be reused in connection with a plurality of different requests to redeem rewards for different benefits.
